(19) United States
(12) Patent Application Publication
(10) Pub. No.: US 2004/0257330 A1
(43) Pub. Date: Dec. 23, 2004

(54) Electrophoretic particles and process for producing the same, and electrophoretic display using same

(76) Inventor: Masato Minami, Atsugi-shi (JP)

Correspondence Address: MORGAN & FINNEGAN, L.L.P., 3 WORLD FINANCIAL CENTER, NEW YORK, NY, 10281-2101, US

(21) Appl. No.: 10/766,256

(22) Filed: Jan. 27, 2004

(30) Foreign Application Priority Data
Jan. 30, 2003 (JP) 021741/2003(PAT.)

(51) Int. Cl. G09G 3/34

(52) U.S. Cl. 345/107

(57) ABSTRACT

An electrophoretic particle has a surface to which at least an amphipathic residual group derived from a reactive surfactant is fixed.

### FIELD OF THE INVENTION AND RELATED ART

The present invention relates to electrophoretic particles and a process for producing the electrophoretic particles, and an electrophoretic display using the electrophoretic particles.

In recent years, with development of information equipment, the needs for low-power and thin display apparatuses have grown, so that extensive study and development have been made on display apparatuses fitted to these needs. Of these display apparatuses, a liquid crystal display apparatus has been developed actively as a display apparatus capable of meeting the needs by electrically controlling alignment of liquid crystal molecules to change optical characteristic of the liquid crystal and has been brought into the commercial stage.

However, the liquid crystal display apparatus is accompanied with such problems that it has poor viewability of characters on a picture area due to a viewing angle or reflection light and that an eyestrain problem caused by flickering, low luminance, etc., of a light source is not sufficiently solved. For this reason, a display apparatus with less eyestrain has been extensively studied.

As one of such display apparatus, an electrophoretic display has been proposed by Harold D. Lees et al. (e.g., U.S. Pat. No. 3,612,758).

FIG. 8 shows an embodiment of a sectional structure and an operational principle of a conventional electrophoretic display. Referring to FIG. 8, the electrophoretic display includes a pair of substrates 8a and 8b oppositely disposed with a predetermined spacing, and electrodes 8c and 8d disposed on the substrates 8a and 8b, respectively. At the spacing between the substrates 8a and 8b, a large number of electrophoretic particles 8e which have been positively charged and colored, and a dispersion medium 8f which has been colored a color different from that of the electrophoretic particles 8e are disposed and filled. Further, a partition wall 8g is disposed so that it divides the spacing into a large number of pixels along a planar direction of the substrates, thus preventing localization of the electrophoretic particles 8e and defining the spacing between the substrates.

In such an electrophoretic display, when the lower electrode 8c is supplied with a negative-polarity voltage and the upper electrode 8d is supplied with a positive-polarity voltage as shown in FIG. 8(a), the positively charged electrophoretic particles 8e get together so as to cover the lower electrode 8c. When this electrophoretic display is viewed from a direction of an indicated arrow A, display of the same color as the dispersion medium is effected. On the other hand, when the lower electrode 8c is supplied with the positive-polarity voltage and the upper electrode 8d is supplied with the negative-polarity voltage as shown in FIG. 8(b), the electrophoretic particles 8e get together so as to cover the upper electrode 8d. When this electrophoretic display is viewed from the indicated arrow A direction, display of the same color as the electrophoretic particles 8e is effected. Such a driving of the electrophoretic display is effected on a pixel-by-pixel basis, whereby arbitrary images or characters are displayed at the large number of pixels.

In such a conventional electrophoretic display, chargeability and dispersibility have been imparted to the electrophoretic particles in an insulating dispersion medium by adding a charging agent, a dispersing agent, etc.

In recent years, a proposal for improving the dispersibility of electrophoretic particles has been made by a method wherein a polymer is grafted at the surface of the electrophoretic particles (U.S. Pat. No. 6,117,368).

When an electrophoretic display including an electrophoretic liquid in which the charging agent or the dispersing agent is added to the electrophoretic particles is driven for a long time, the charging agent or the dispersing agent which has been adsorbed by the electrophoretic particles is desorbed. As a result, the electrophoretic display has been accompanied with such problems that the electrophoretic particles are insufficiently charged and that a display quality is lowered by agglomeration of the electrophoretic particles.

The proposal for improving the dispersibility of the electrophoretic particles is effective in improving the particle dispersibility but cannot provide a sufficient chargeability unless the charging agent is added to the electrophoretic particles. Accordingly, the problem of display degradation due to the desorption of the electrophoretic particles from the particle surface has not been solved basically.

### SUMMARY OF THE INVENTION

An object of the present invention is to provide electrophoretic particles and a production process of the electrophoretic particles capable of exhibiting a chargeability and a dispersibility without adding thereto a charging agent and a dispersing agent.

Another object of the present invention is to provide an electrophoretic display with high reliability causing no agglomeration of electrophoretic particles and display degradation even when the electrophoretic display is driven for a long time.

According to the present invention, there is provided an electrophoretic particle having a surface to which at least an amphipathic residual group derived from a reactive surfactant is fixed.

Such electrophoretic particles may preferably be selected from the group consisting of pigment particles, polymer-coated pigment particles, and polymer particles colored with a dye.

The reactive surfactant may preferably have a reactive function group comprising an unsaturated hydrocarbon group.

The reactive surfactant has a hydrophobic portion comprising an aliphatic hydrocarbon chain having 4-30 carbon atoms.

The reactive surfactant may preferably have a hydrophobic portion comprising an ionic functional group, and the chargeability of the electrophoretic particles can be exhibited by dissociation (ionization) of the ionic functional group in the insulating solvent. Further, the dispersibility of the electrophoretic particles in the insulating solvent can be exhibited by an steric-exclusion effect of the hydrophobic portion at the particle surface and an electrostatic repulsion effect of the ionic functional portion.

According to the present invention, there is also provided an electrophoretic liquid comprising electrophoretic particles described above and an insulating solvent as a dispersion medium.

According to the present invention, there is further provided an electrophoretic display comprising: a pair of substrates, a first electrode and a second electrode which are disposed on the pair of substrates, an electrophoretic liquid, comprising electrophoretic particles and a dispersion medium, disposed between the pair of substrates, the electrophoretic particles being moved by applying a voltage to the first and second electrodes to effect display, wherein each of the electrophoretic particles has a surface to which at least an amphipathic residual group derived from a reactive surfactant is fixed.

According to the present invention, there is further provided a process for producing electrophoretic particles, comprising the steps of: adsorbing at least a reactive surfactant on a particle surface, and fixing an amphipathic residual group attributable to the reactive surfactant to the particle surface by a chemical reaction of a reactive functional group possessed by the reactive surfactant.

In the production process of the present invention, the chemical reaction of the reactive functional group possessed by the reactive surfactant may preferably be polymerization reaction. Further, the amphipathic residual group attributable to the reactive surfactant may preferably be fixed to the particle surface by a copolymerization reaction of the reactive surfactant with a comonomer.

A particle size of the electrophoretic particles produced through the above-described process is substantially identical to a particle size of particles to be reacted with the reactive surfactant, so that it is not necessary to effect post-treatment such as pulverization.

In the present invention, at least the reactive surfactant, so that it is not necessary to effect post-treatment such as pulverization.

In the present invention, at least the reactive surfactant-derive amphipathic residual group is fixed at the particle surface, so that a deterioration in chargeability is hardly caused to occur since the ionic functional group which is responsible for the chargeability is not desorbed.

Further, based on the steric-exclusion effect by the hydrophobic portion of the surface of the electrophoretic particles and the electrostatic repulsion effect by the ionic functional group, the electrophoretic particles of the present invention exhibit a good dispersibility in the insulating solvent.

According to the present invention, without adding the charging agent or the dispersion agent, it is possible to provide the electrophoretic particles exhibiting chargeability and dispersibility. Further, by using the electrophoretic particles of the present invention, it is possible to provide a high responsible electrophoretic display which causes no agglomeration of electrophoretic particles and display degradation even when the electrophoretic display is driven for a long time.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIGS. 1(a) and 1(b) are sectional views showing an embodiment of the electrophoretic display using electrophoretic particles according to the present invention.

FIGS. 2(a) to 2(c) and FIGS. 3(a) to 3(c) are respectively schematic views for illustrating the production process of the present invention wherein electrophoretic particles to which a reactive surfactant-derived amphipathic residual group is fixed are produced.

FIGS. 4(a) and 4(b) and FIGS. 5(a) and 5(b) are respectively schematic views showing a display embodiment of the electrophoretic display using electrophoretic particles of the present invention.

FIGS. 6(a) and 6(b) are sectional views showing another embodiment of the electrophoretic display using electrophoretic particles of the present invention.

FIGS. 7(a) and 7(b) are schematic views showing another display embodiment of the electrophoretic display using electrophoretic particles of the present invention.

FIGS. 8(a) and 8(b) are schematic views of a conventional electrophoretic display.

### DETAILED DESCRIPTION OF THE PREFERRED EMBODIMENTS

Hereinbelow, embodiments of the electrophoretic display using electrophoretic particles according to the present invention will be described with reference to the drawings.

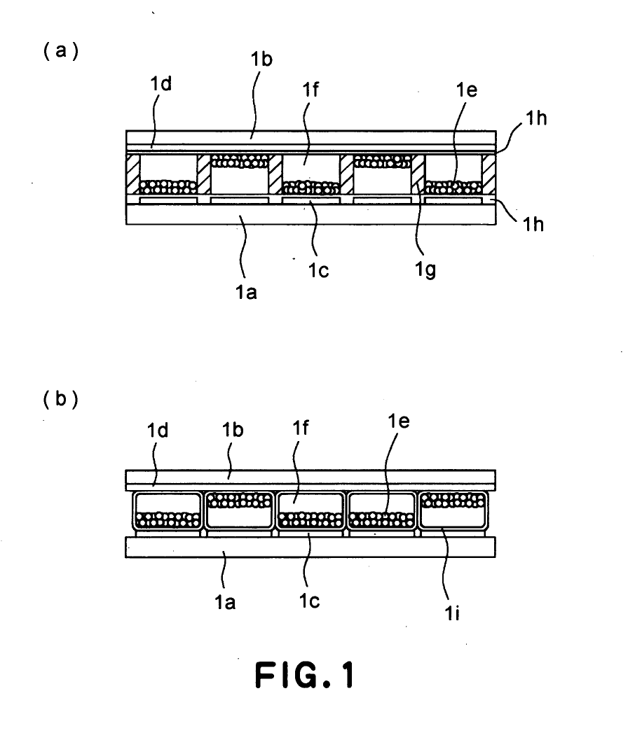

FIG. 1 shows an embodiment of the electrophoretic display using electrophoretic particles of the present invention.

Referring to FIG. 1(a), the electrophoretic display includes a pair of first and second substrates 1a and 1b provided with first and second electrodes 1c and 1d, respectively are oppositely disposed with a predetermined spacing through a partition wall 1g. At a cell (space) defined by the first and second substrates 1a and 1b and the partition wall 1g, an electrophoretic liquid comprising electrophoretic particles 1e and a dispersion medium 1f are filled and sealed in. Further, on the respective electrodes, an insulating layer 1h is formed.

A display surface of the electrophoretic display of this type is on the second substrate 1b side.

FIG. 1(b) shows an electrophoretic display using microcapsules. A plurality of microcapsules 1i each including therein the electrophoretic liquid comprising the electrophoretic particles 1e and the dispersion medium 1f are disposed on the first substrate 1a and is covered with the second substrate 1b. In the case of using the microcapsules 1i, the insulating layer 1h can be omitted as shown in FIG. 1(b).

Referring to FIGS. 1(a) and 1(b), the first electrodes 1c are pixel electrodes which can independently apply a desired electric field to the electrophoretic liquid within each cell (or microcapsule), and the second electrodes 1d are a common electrode for applying a voltage at an identical potential over the entire area. Each of the pixel electrodes is provided with a switching device, and is supplied with a selection signal every row line from an unshown matrix drive circuit and supplied with a control signal very column line and an output from a driving transistor, thus allowing a desired electric field to the electrophoretic liquid within each cell (or microcapsule). The electrophoretic particles within each cell (or microcapsule) are controlled by the electric field supplied by the first electrode 1c, whereby at each pixel, the color (e.g., white) of the electrophoretic particles and the color (e.g., blue) of the dispersion solvent are selectively displayed. By effecting such a drive on one pixel basis, it is possible to effect display of arbitrary images and characters at a number of pixels.

The first substrate 1a is an arbitrary insulating member for supporting the electrophoretic display and may be formed of glass or plastics. The first electrode 1c may be formed of a metal (vapor) deposition film of ITO (indium tin oxide), tin oxide, indium oxide, gold, chromium, etc., in a predetermined pattern through a photolithographic process. The second electrode 1d may be formed of a transparent glass substrate or a transparent plastic substrate. The insulating layer 1h can be formed of a colorless transparent insulating resin, such as acrylic resin, epoxy resin, fluorine-based resin, silicone resin, polyimide resin, polystyrene resin, or polyalkene resin.

The partition wall 1g can be formed of a polymeric material through any method. For example, it is possible to use a method wherein the partition wall is formed with a photosensitive resin through the photolithographic process, a method wherein the partition wall which has been prepared in advance is bonded to the substrate, a method wherein the partition wall is formed through molding, or the like.

The method of filling the electrophoretic liquid is not particularly limited but can be an ink jet method using nozzles.

The microcapsules 1i enclosing the electrophoretic liquid can be prepared through a known method, such a an interfacial polymerization, an in situ polymerization, or coascervation method.

A material for forming the microcapsules 1i may preferably include a material which permits sufficient light transmission. Examples of the material may include urea-formaldehyde resin, metamine-formaldehyde resin, polyester, polyurethane, polyamide, polyethylene, polystyrene, polyvinyl alcohol, gelatin, and copolymers thereof.

The arrangement of the microcapsules 1i on the first substrate 1a is not limited particularly but may be performed through the ink jet method using nozzles.

As the dispersion medium 1f, it is possible to use a liquid, which is high insulative and colorless and transparent, including: aromatic hydrocarbons, such as toluene, xylene, ethylbenzene and dodecylbenzene; aliphatic hydrocarbons, such as hexane, cyclohexane, kerosine, normal paraffin and isoparaffin; halogenated hydrocarbons, such as chloroform, dichloromethane, pentachloromethane, tetrachloroethylene, trifluoroethylene and tetrafluoroethylene, various natural or synthetic oils, etc. These may be used singly or in mixture of two or more species.

The dispersion liquid 1f may be colored with oil soluble dye having a color of R (red), G (green), B (blue), C (cyan), M (magenta), Y (yellow), etc. Examples of the dye may preferably include azo dyes, anthraquinone dyes, quinoline dyes, nitro dyes, nitroso dyes, penoline dyes, phthalocyanine dyes, metal complex salt dyes, naphthol dyes, benzoquinone dyes, cyanine dyes, indigo dyes, quinoimine dyes, etc. These may be used in combination.

Specific examples of the oil soluble dye may include Vari Fast Yellow (1101, 1105, 3108, 4120), Oil Yellow (105, 107, 129, 3G, GGS), Vari Fast Red (1306, 1355, 2303, 3304, 3306, 3320), Oil Pink 312, Oil Scarlet 308, Oil Violet 730, Vari Fast Blue (1501, 1603, 1605, 1607, 2606, 2610, 3405). Oil Blue (2N, BOS, 613), Macrolex Blue RR, Sumiplast Gren G, Oil Green (502, BG), etc. A concentration of these dyes may preferably be 0.1-3.5 wt. %.

At the particle surface of the electrophoretic particles of the present invention, at least an amphipathic residual group derived from a reactive surfactant is fixed. Particles used for reaction may include organic or inorganic particles, pigment particles coated with a polymer, and polymer particles coated with a dye. An average particle size of these particles may be 10 nm to 5 μm, preferably 15 nm to 2 μm.

Examples of organic pigments may include azo pigments, phthalocyanine pigments, quinacridone pigments, isoindolinone pigments isoindolin pigments, dioazine pigments, perylene pigments, perinone pigments, thioindigo pigments, quinophthalone pigments, anthraquinone pigments, nitro pigments, and nitroso pigments. Specific examples thereof may include: rod pigments, such as Quinacridone Red, Lake Red, Brilliant Carmine, Perylene Red, Permanent Red, Toluidine Red and Madder Lake; green pigments, such as Diamond Green Lake, Phthalocyanine Green, and Pigment Green; blue pigments, such as Victoria Blue Lake, Phthalocyanine Blue, and Fast Sky Blue; yellow pigments, such as Hansa Yellow, Fast Yellow, Disazo Yellow, Isoindolinone Yellow, an Quinophthalone Yellow; and black pigments, such as Aniline Block and Diamond Black.

Examples of the inorganic pigments may include: white pigments, such as titanium oxide, aluminum oxide, zinc oxide, lead oxide, and zinc sulfide; black pigments, such as carbon black, manganese ferrite block, cobalt ferrite black, and titanium black; red pigments, such as cadmium red, red iron oxide, and molybdenum red; green pigments, such as chromium oxide, viridian, titanium cobalt green, cobalt green, and victoria green; blue pigments, such as ultramarine blue, prussian blue, and cobalt blue; and yellow pigments, such as cadmium yellow, titanium yellow, yellow iron oxide, chrome yellow, and antimony yellow.

As the pigment particles coated with a polymer, it is possible to use particles of the above described pigments coated with a polymer, such as polystyrene, polyethylene, polymethylacrylate, and polymethylmethacrylate. Coating of the pigment particles with the polymer may be performed by using a known method such as a polymer precipitation method or suspension polymerization.

As the polymer particles colored with a dye, it is possible to use particles of preliminarily synthesized crosslinkable polymer fine particles colored with a dye, particles obtained through suspension polymerization or emulsion polymerization of a polymerizable monomer containing a dye, etc.

In the electrophoretic particles of the present invention to which surface at least the reactive surfactant-derived amphipathic residual group is fixed, when the reactive surfactant is adsorbed by the particle surface and co-polymerized, a comonomer to be co-polymerized with the reactive surfactant is solubilized in the adsorption layer and polymerized or co-polymerized with the use of a polymerization initiator. As a result, the reactive surfactant-derived amphipathic residual group is fixed at the particle surface.

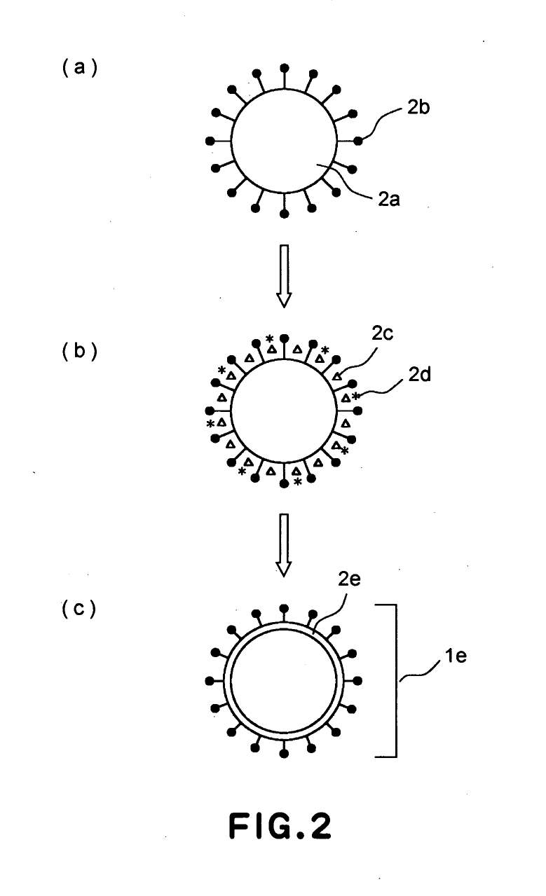

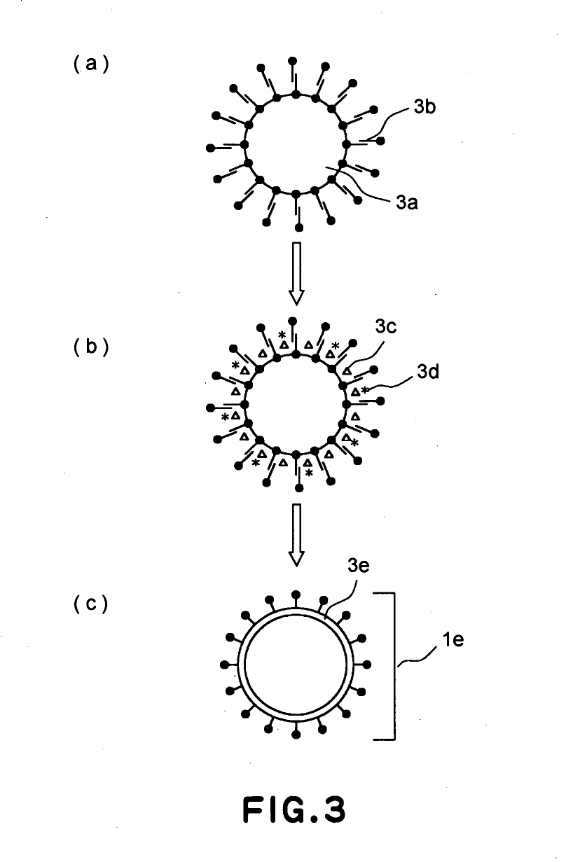

The production process of the electrophoretic particles 1e is shown in FIGS. 2 and 3. FIG. 2(a) to 2(c) show production steps in the cases of using the organic pigment particles, the polymer-coated pigment particles and the polymer particles colored with a dye as the reaction particles, and FIGS. 3(a) to 3(c) show production steps in the case of using the inorganic pigment particles.

FIG. 2(a) illustrates a step of forming an adsorption layer of the reactive surfactant 2h by adsorbing the hydrophobic portion of the reactive surfactant 2b to the surface of an organic pigment particle 2a by the action of hydrophobic interaction. The manner of forming the adsorption layer of the reactive surfactant 2b is not particularly limited but may be such a manner that the organic pigment particles 2a and the reactive surfactant 2b are mixed in a medium and are then subjected to ultrasonic irradiation or stirring to form the adsorption layer. Examples of the medium may include water, methanol, acetone, tetrahydrofurane, etc., preferably water.

FIG. 2(b) illustrates a step of solubilizing a comonomer 2c in the adsorption layer formed at the surface of the particle 2a by adding the comonomer 2c and a polymerization initiator 2d and depositing the polymerization initiator 2d. In the case of the organic particles, the reactive surfactant 2b is not readily polymerized alone, so that it is preferable that the comonomer 2c is added to the reactive surfactant 2b. The order of addition of the comonomer 2c and the polymerization initiator 2d may be any order. More specifically, the comonomer 2c can be added before or after the polymerization initiator 2d or added simultaneously with the polymerization initiator 2d.

FIG. 2(c) illustrates a step of fixing the reactive surfactant 2b derived amphipathic residual group on a polymerization film 2e by forming a uniform polymerization film 2e on the surface of the particle 2a through copolymerization of the comonomer 2c solubilized in the adsorption layer with the reactive surfactant 2b. Polymerization conditions therefor will be described later.

Then, FIG. 3(a) illustrates a step of forming a bimolecular adsorption layer of a reactive surfactant 3b by adsorbing a hydrophilic portion of the reactive surfactant 3b to an inorganic pigment particle 3a in a medium. When the surface of the inorganic pigment particle 3a is negatively charged, a reactive surfactant 3b having a cationic functional group described later may preferably be used. On the other hand, when the surface of the inorganic pigment particle 3a is positively charged, a reactive surfactant 3b having an anionic functional group described later may preferably be used. In these cases, the ionic functional group of the reactive surfactant 3b is electrically attracted to the surface of the inorganic pigment particle 3a, whereby a hydrophobic portion of the reactive surfactant 3b is oriented in an outward direction of the inorganic pigment particle 3a. By controlling an amount of addition of the reactive surfactant 3b, the hydrophobic interaction acts between the hydrophobic portions of the reactive surfactant 3b. As a result, the bimolecular adsorption layer as shown in FIG. 3(a) is formed. The manner of forming the bimolecular adsorption layer is not particularly limited but may be a manner using ultrasonic irradiation or stirring as described above. As the medium, similarly as in the case of the organic pigment particles, water may preferably be used.

FIG. 3(b) illustrates a step of solubilizing a comonomer 3c in the bimolecular adsorption layer formed at the surface of the inorganic pigment particle 3a by adding the comonomer 3c and a polymerization initiator 3d and depositing the polymerization initiator 3d. The order of addition of the comonomer 3c and the polymerization initiator 3d may be the same as in the case of the organic pigment particles described above. Further, in the case of the inorganic pigment particles, the comonomer 3c may be omitted since the homopolymerization of the reactive surfactant 3b can also be effected.

FIG. 3(c) illustrates a step of fixing the reactive surfactant 3b derived amphipathic residual group on a polymerization film 3e by forming a uniform polymerization film 3e on the surface of the particle 3a through copolymerization of the comonomer 3c solubilized in the bimolecular adsorption layer with the reactive surfactant 3b. Polymerization conditions therefor will be described later.

The reactive surfactant used in the present invention may include compounds represented by the following formulas (1) and (2).

X—Y—Z (1)

X—Z—Y (2)

In the formulas (1) and (2), X represents a reactive functional group of the reactive surfactant, Y represents a hydrophobic portion of the reactive surfactant, and Z represents a hydrophilic group of the reactive surfactant. The formula (1) is of a tail type wherein the reactive functional group is located at a terminal of the hydrophobic portion. On the other hand, the formula (2) is of a head type wherein the reactive functional group is located in the vicinity of the hydrophilic portion.

The reactive functional group X in the formulas (1) and (2) may preferably be an unsaturated hydrocarbon group, such as vinyl group (CH₂═CH—), allyl group (CH₂═CHCH₂—), propenyl group (CH₃CH═CH—), methallyl group (CH₂═CH(CH₃)CH₂—), acryloyl group (CH₂═CHCO—), acrylic group (CH₂═CHCOO—), methacryloyl group (CH₂═C(CH₃)COO—), methacryl group (CH₂═C(CH₃)COO—), crotonoyl group (CH₃CH═CHCO—), acrylamide group (CH₂═CHCONH—), methacrylamido group (CH₂═C(CH₃)CONH—), maleic acid residual group (—OOCHC═CHCOO—), vinylphenyl group (CH₂═CH—Φ; Φ=benzene ring), and propenylphenyl group (CH₃CH═CH—Φ—).

The hydrophobic group Y in the formulas (1) and (2) is an aliphatic hydrocarbon chain having 4-30 carbon atoms, preferably 4-20 carbon atoms. The aliphatic hydrocarbon chain may be linear or branched and may contain a part or all of hydrogen atoms optionally substituted with a halogen atom or an aromatic group.

The hydrophilic portion in the formulas (1) and (2) may preferably be an ionic functional group including: an anionic functional group, such as carboxylates (—COOM), sulfates (—OSO₃M), sulfonates (—SO₃M), phosphates (—OPO(OM)₂), or phosphites (—OP(OM)₂); and a cationic functional group, such as ammonium salts (—N⁺R₃.Q—), pyridium salts (represented by formula (3) shown below), imidazolium salts (represented by formula (4) shown below), morphonium salts (represented by formula (5) shown below), sulfonium salts (—SR₂.Q—) or phosphonium salts (—P⁺R₃.Q—).

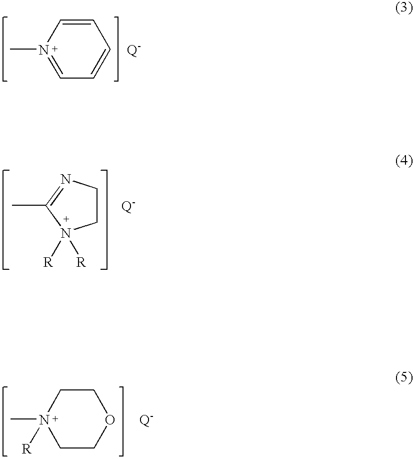

In the above, M represents a metal ion such as sodium, potassium, magnesium or calcium; or a cation, such as ammonium. Examples of the ammonium may include ammonia, methylamine, ethylamine, propylamine, dimethylamine, diethylamine, dipropylamine, monoethanolamine, N-methyl monoethanolamine, N-ethylmonoethanolamine, diethanolamine, triethanolamine, monopropanolamine, dipropanolamine, tripropanolamine, 2-amino-2-methyl-1,3-propandiol, aminoethylethanolamine, N,N,N′,N′-tetrakis-(hydroxyethyl)ethylenediamine, or N,N,N′,N′-tetrakis(2-hydropropyl)ethylenediamine.

Q represents an anion, such as hydroxide ion, halogen ion, perhalogen acid ion, hydrogensulfate ion, alkyl sulfate ion, or p-toluenesulfonate ion.

R represents an alkyl group, and all the R groups may be the same or different from each other.

Specific examples of the reactive surfactant of the formula (1) may include Example Compounds Nos. (6) to (29), and specific examples of the reactive surfactant of the formula (2) may include Example Compounds Nos. (30) to (32). In the formulas for Ex. Comp. Nos. (6) to (32), n and m are an integer of 4-30, and R represents an alkyl group and may be the same or different from each other when two or more R groups present in the formulas.

Further, the reactive surfactant used in the present invention may have a linkage, such as ester group or amido group, between the hydrophobic portion and the hydrophilic portion as in Ex. Comp. No. (29).

CH₂═CH—(CH₂)ₙ—COOM (6)

CH₂═CHCOO—(CH₂)ₙ—COOM (7)

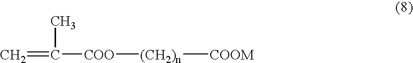

CH₃—CH ═CH—(CH₂)ₙ—COOM (9)

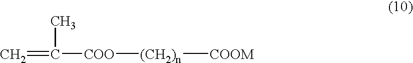

CH₂═CHCONH—(CH₂)ₙ—COOM (11)

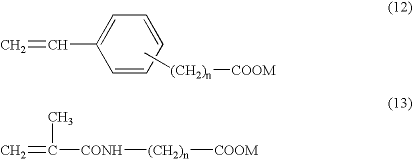

CH₂═CHCO—(CH₂)ₙ—COOM (14)

CH₂═CH—(CH₂)ₙ—SO₃M (15)

CH₂═CHCOO—(CH₂)ₙ—SO₃M (16) 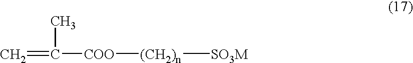
CH₂═CHCONH—(CH₂)ₙ—SO₃M (18) 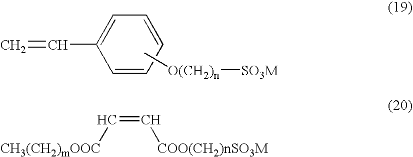 CH₂═CH—(CH₂)ₙ—OSO₃M (21) 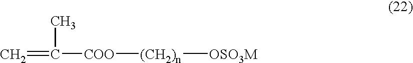 CH₂═CH—(CH₂)ₙ—OPO(OM)₂ (23) 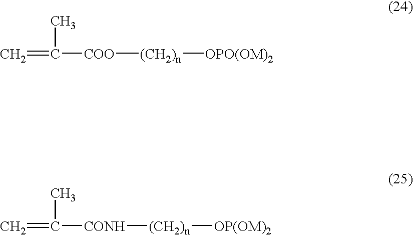 CH₂═CH—(CH₂)ₙ—OP(OM)₂ (26)

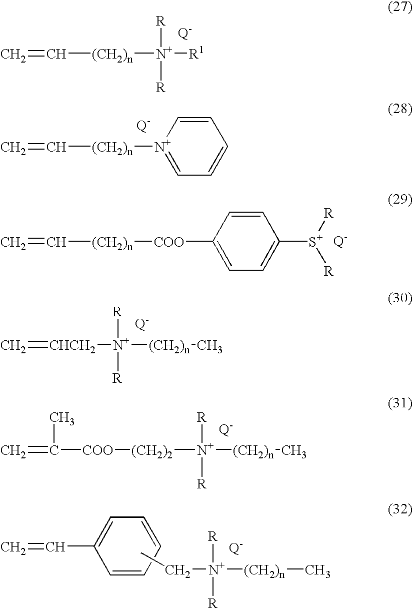

The reactive surfactant may be used singly or in mixture of two or more species. The comonomer usable with the reactive surfactant is not particularly limited so long as it exhibits a high copolymerization performance when used in combination with the reactive surfactant. Specific examples of the comonomer may include: acrylates, such as acrolonitrile, methylene malononitrile, fumaronitrile, maleonitrile, acryic acid, methyl acrylate, ethyl acrylate, butyl acrylate, hydroxyethyl acrylate, phenyl acrylate, and benzyl acrylate; methacrylates, such as methacrylic acid, methyl methacrylate, ethyl methacrylate, butyl methacrylate, hydroxyethyl methacrylate, phenyl methacrylate, and benzyl methacrylate; fumaric acid diesters, such as itaconic acid esters, diethyl fumarate, dibutyl fumarate, and dioctyl fumarate; maleic acid diesters, such as diethyl maleate, dibutyl maleate, and dioctyl maleate; maleimides; acrylamides, such as acrylamide, N-methoxyacrylamide, N-ethylacrylamide, and N-propylacrylamide; methacrylamides, such as methacrylamide, N-methylmethacrylamide, N-ethylmethacrylamide, and N-propylmethacrylamide; aromatic vinyl compounds, such as styrene, α-methylstyrene, chloromethylstyrene, ethylstyrene, and divinylstyrene; vinyl compounds, such as vinyl acetate, vinyl chloride, vinylidene chloride, divinyl ether, alkylvinyl ether, vinylallyl ether, N-vinylcarbazol, N-vinylamide, N-vinylimide, and N-vinyl pyrrolidone; and diene-based compounds, such as butadiene, isoprene and chloroprene. These may be used singly or in combination of two or more species.

As the polymerization initiator, it is possible to use potassium persulfate, sodium persulfate, ammonium persulfate, hydrogen peroxide, azobis(2-methylpropanenitrile), 2,2′-azobis(2-aminoisopropane)dihydrochloride, 2,2′-azobisisodi-methylbutylate, 4,4′-azobis(4-cyanovaleric acid), azobiscyanovaleric acid chloride, 1,1′-azobis-(cyclohexane-1-carbonitrile), 2,2′-azobis(2,4-dimethylvaleronitrile), 2,2′-azobis(4-methoxy-2,4-dimethylvaleronitrile), azobisisobutyronitrile, 2,2′-azobis(2-cyanopropanol), 4,4′-azobis(4-cyanopentanol), benzoyl peroxide, cumeme hydroperoxide, and lauroyl peroxide.

Fixation of the reactive surfactant-derived amphipathic residual group onto the particle surface is effected by such a method that particles and a reactive surfactant are added in a medium and sufficiently dispersed by ultrasonic irradiation or stirring and thereafter, a polymerization initiator and optionally a comonomer in the case of copolymerization are added thereto, and a polymerization reaction is effected for 10-72 hours at 40-100° C. in a nitrogen atmosphere. After the polymerization reaction, coarse particles are removed by sieving, etc., and particles in the medium are separated by a method such as a centrifuge process, etc., followed by filtering, washing and drying of a precipitate to obtain particles to which the amphipathic residual group derived from the reactive surfactant is fixed.

An amount of addition of the medium is 5-2000 times, preferably 10-1000 times, the volume of the particles. As the medium, it is possible to use the solvents described above but the use of water is preferred.

A concentration of the reactive surfactant is 1-150 wt. %, preferably 5-100 wt. %, per the particles. In the case where the concentration of the reactive surfactant is below 1 wt. %, stable dispersion of the particles are not attained. On the other hand, if the concentration exceeds 150 wt. %, a reactive surfactant which does not adsorb the particle surface is undesirably caused to occur.

A concentration of the comonomer co-polymerized with the reactive surfactant is 0.1-30 (molar ratio), preferably 0.5-10 (molar ratio), per the reactive surfactant. When the concentration of the comonomer is below 0.1 molar ratio, the resultant copolymer is water soluble, thus undesirably resulting in a small polymerization coverage. On the other hand, the concentration exceeds 30 molar ratio, the comonomer cannot be solubilized in the adsorption layer of the reactive surfactant, so that generation of water insoluble polymer or giant particles is undesirably caused in water.

The salt of the reactive surfactant may be substituted with an arbitrary salt, particularly a salt which is readily dissociated in the dispersion medium, after being fixed to the particle surface. Examples of the salt (M) may include: tetraalkylammonium salt, such as tetramethylammonium ion, tetraethylammionium ion, tetrabutylammonium ion, and n-hexadecyltrimethylammonium ion; trialkylbenzylammonium ion; alkypyridium ion; and N,N-dialkylmorphonium ion.

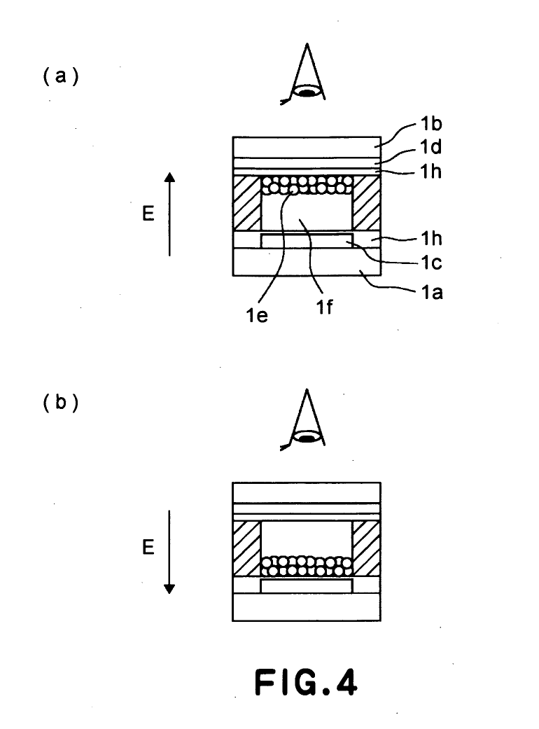

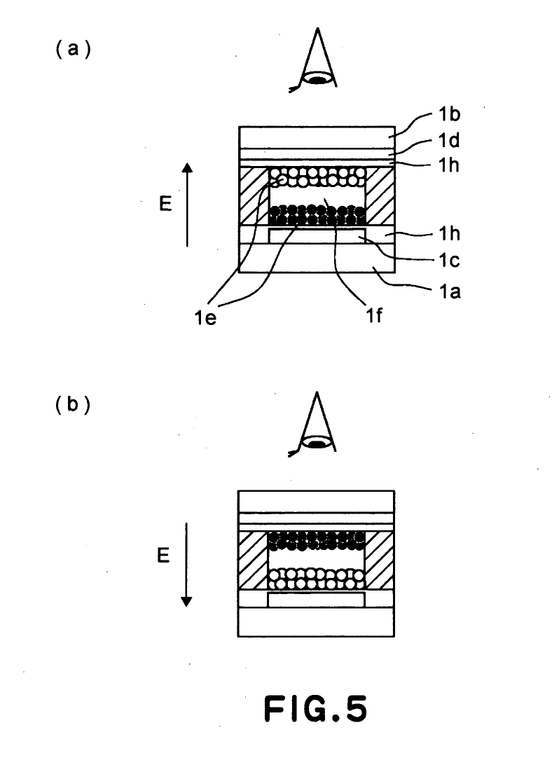

A display embodiment of the electrophoretic display using electrophoretic particles 1e according to the present invention are shown in FIGS. 4 and 5.

FIGS. 4(a) and 4(b) show a display embodiment of the case where an electrophoretic liquid comprising white electrophoretic particles 1e and a dispersion medium 1f colored with a blue dye is filled in a cell. The electrophoretic particles 1e are positively charged by fixing an amphipathic residual group derived from a reactive surfactant having a cationic functional group. When an electric field E is applied to the electrophoretic liquid in the direction shown in FIG. 4(a), the positively charged electrophoretic particles 1e are moved toward the upper side of the cell and distributed over the upper display surface. As a result, when the cell is observed from above, the cell looks white due to distribution of the white electrophoretic display 1e. On the other hand, when the electric field E is applied to the electrophoretic liquid in the arrow direction shown in FIG. 4(b), the white electrophoretic particles 1e are moved toward the bottom of the cell and distributed thereover, so that the cell looks blue when observed from above. Such a driving operation is effected pixel by pixel, whereby arbitrary images or characters can be displayed by using a large number of pixels.

FIGS. 5(a) and 5(b) show a display embodiment of the case using a colorless dispersion medium 1f and two types (white and black) of electrophoretic particles 1e. The white electrophoretic particles 1e are positively charged by fixing an amphipathic residual group derived from a reactive surfactant having a cationic functional group, and the black electrophoretic particles 1e are negatively charged by fixing an amphipathic residual group derived from an anionic functional group. When an electric field E is applied to the electrophoretic liquid in the direction shown in FIG. 5(a), the positively charged white electrophoretic particles 1e are moved toward the upper side of the cell and the negatively charged black electrophoretic particles 1e are moved toward the lower (bottom) side of the cell. As a result, when the cell is observed from above, the cell looks white due to distribution of the white electrophoretic display 1e. On the other hand, when the electric field E is applied to the electrophoretic liquid in the arrow direction shown in FIG. 5(b), the black electrophoretic particles 1e are moved toward the upper side of the cell, and the white electrophoretic particles 1e are moved toward the bottom of the cell, so that the cell looks black when observed from above. Such a driving operation is effected pixel by pixel, whereby arbitrary images or characters can be displayed by using a large number of pixels.

Another embodiment of the electrophoretic display using electrophoretic particles of the present invention will be explained with reference to the drawings.

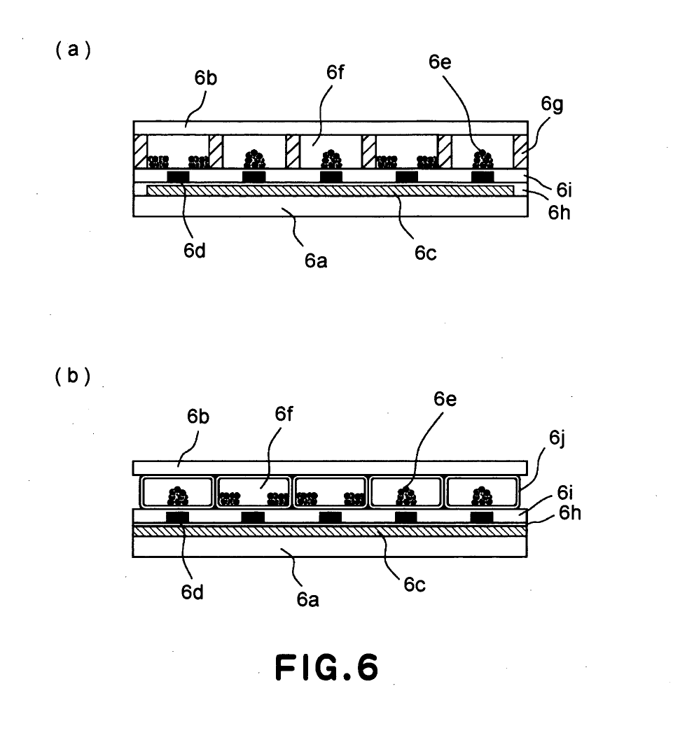

FIGS. 6(a) and 6(b) are schematic sectional views thereof.

Referring to FIG. 6(a), the electrophoretic display includes a pair of first and second substrates 6a and 6b disposed oppositely to each other with a predetermined spacing through a partition wall 6g. On the first substrate 6a, a first electrode 6c and a second electrode 6d are disposed. Between the electrodes and on the second electrode 6d, insulating layers 6h and 6i are formed, respectively. The insulating layer 6h may be colored or colorless and transparent but the insulating layer 6i is colorless and transparent. In a cell (space) defined by the first substrate 6a, the second substrate 6b, and the partition wall 6g, an electrophoretic liquid comprising electrophoretic particles 6e and a dispersion medium 6f is filled and sealed in. A display surface of the electrophoretic particles is on the second substrate 6b side.

FIG. 6(b) shows an electrophoretic display using microcapsules. Referring to FIG. 6(b), microcapsules 6j each containing therein an electrophoretic liquid comprising electrophoretic particles 6e and a dispersion medium 6f are disposed on a first substrate 6a and is covered with a second substrate 6b. In this case an insulating layer 6i may be omitted.

In FIGS. 6(a) and 6(b), the second electrodes 6b are pixel electrodes which can independently apply a desired electric field to the electrophoretic liquid within each cell (or microcapsule), and the first electrodes 6c are a common electrode for applying a voltage at an identical potential over the entire area. Each of the pixel electrodes is provided with a switching device, and is supplied with a selection signal every row line from an unshown matrix drive circuit and supplied with a control signal very column line and an output from a driving transistor, thus allowing a desired electric field to the electrophoretic liquid within each cell (or microcapsule). The electrophoretic particles 6e within each cell (or microcapsule) are controlled by the electric field supplied by the second electrode 6d, whereby at each pixel, the color (e.g., black) of the electrophoretic particles and the color (e.g., white) of the insulating layer 6h are selectively displayed. By effecting such a drive on one pixel basis, it is possible to effect display of arbitrary images and characters at a number of pixels.

The first substrate 6a is an arbitrary insulating member for supporting the electrophoretic display and may be formed of glass or plastics. The second substrate 6b may also be formed of the same material as the first substrate 6a.

The first electrode 6c is a metal electrode of, e.g., Al exhibiting light reflection performance.

The insulating layer 6h formed on the first electrode 6c is formed of a mixture of a transparent colorless insulating resin with light scattering fine particles of, e.g., aluminum oxide or titanium oxide. As a material for the transparent colorless insulating resin, it is possible use the above described insulating resins. Alternatively, it is possible to use a light scattering method utilizing unevenness at the surface of the metal electrode without using the fine particles.

The second electrode 6d is formed of an electroconductive material, which looks dark black from the viewer side of the electrophoretic display, such as titanium oxide, black-treated Cr, and Al or Ti provided with a black surface layer. Pattern formation of the second electrode 6d may be performed through a photolithographic process.

On the second electrode 6d, the insulating layer 6i is formed of, e.g., the transparent colorless insulating resin described above.

In this embodiment, a display contrast is largely depend on an areal ratio between the second electrode 6d and the pixel, so that an exposed area of the second electrode 6d is required to be smaller than that of the pixel in order to enhance a contrast. For this reason, it is preferable that the areal ratio therebetween may ordinarily be 1:2 to 1:5.

With respect to the partition wall 6g, the partition wall forming method similar to that described above can be employed. The filling method of the electrophoretic particles described above in the cell is not particularly limited but it is possible to use the ink jet method using nozzles.

The microcapsules enclosing the dispersion liquid described above can be prepared through the known processes such as interfacial polymerization, in situ polymerization and coascervation process, as described above. As a material for forming the microcapsules, it is possible to use the above mentioned polymer material similarly.

The method of disposing the microcapsules 6j on the first substrate 6a is not particularly limited but the above described ink jet method using nozzles can be employed.

With respect to the dispersion medium 6f, the above described dispersion mediums can be used similarly. As the electrophoretic particles, those prepared in the same manner as described above are used.

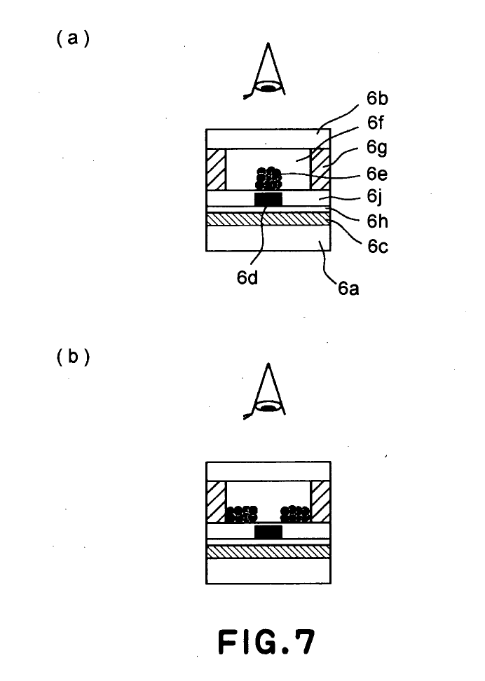

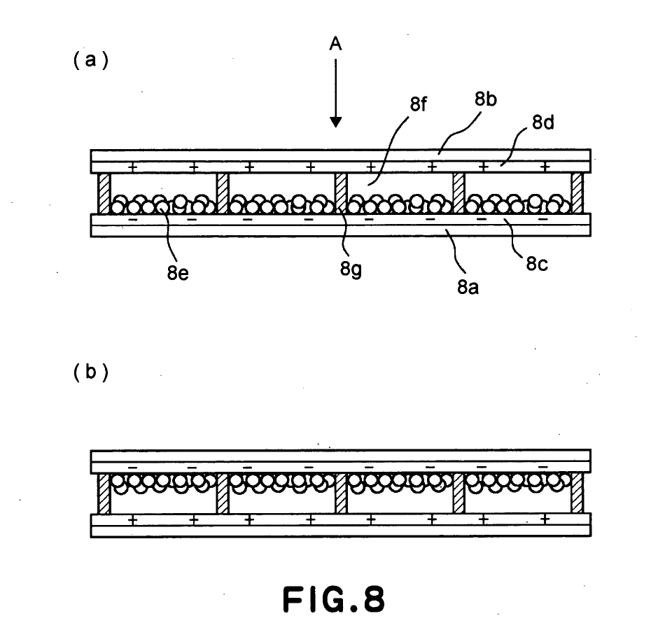

Display is effected by applying a voltage between the electrodes. For example, black electrophoretic particles 6e and a transparent colorless dispersion medium 6f are used and an amphipathic residual group derived from a reactive surfactant having an anionic functional group is fixed at the particle surface of the electrophoretic particles 6e, whereby the electrophoretic particles 6e are negatively charged electrically. In the case where the surface of the insulating layer 6h is white and the surface of the second electrode 6d is black, it is possible to effect white display when the electrophoretic particles 6e gather on the second electrode 6d and possible to effect black display when the electrophoretic particles 6e gather on the first electrode 6c (see FIGS. 7(a) and 7(b)). Such a driving operation is effected on one pixel basis, whereby arbitrary images or characters can be displayed at a large number of pixels.

Hereinbelow, the present invention will be described more specifically on the basis of Examples.

First, synthesis examples of the reactive surfactant used in the present invention will be described.

### Synthesis Example 1

4.8 g (41 mmol) of chlorosulfuric acid was gradually added dropwise to 35 ml of pyridine cooled at 0° C., followed by stirring for 30 minutes. To the reactive mixture, 9 ml of a pyridine solution containing 7.0 g (41 mmol) of 10-undecene alcohol was gradually added dropwise, followed by stirring for 1 hour at 0° C. and further stirring for 20 hours at 55° C. The reaction mixture was poured into a saturated sodium hydrogen-carbonate aqueous solution cooled at 0°C., and stirred for 1 hour and further stirred of 20 hours at room temperature. After the reaction, the solvent of the reaction mixture was distilled off under reduced pressure. To the residue, acetone was added to precipitate a crystal. The crystal was dissolved in methanol and thereafter, a methanol insoluble content was removed, followed by removal of the solvent under reduced pressure to obtain a crystal. The crystal was recrystallized from a mixture solvent (methanol/acetone=⅓) to obtain a reactive surfactant (33) having an anionic functional group represented by the following formula (Yield: 80%).

CH₂═CH—(CH₂)₉-OSO₃Na (33)

As a result of 1H-NMR (400 MHz, CD₃, OD) of the resultant reactive surfactant, measured values (δ/ppm) including 1.33 (12H), 1.68 (2H), 2.02 (2H), 4.00 (2H), 4.95 (2H) and 5.83 (1H) were obtained, thus identifying synthesis of the objective reactive surfactant (33).

### Syntyesis Example 2

12.6 g (80 mmol) of dimethylaminoethyl methacrylate and 17.7 g (80 mmol) of 1-bromododecane were stirred in acetone for 20 hours at 35° C. After the reaction, acetone was distilled off under reduced pressure and anhydrous ether was added to the residue to precipitate a crystal. The crystal was recovered by filtration and was recrystallized from ethyl acetate to obtain a reactive surfactant (34) having a cationic functional group represented by the following formula (Yield: 90%).

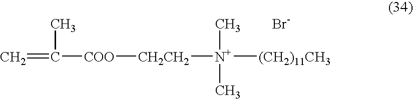

As a result of 1H-NMR (400 MHz, CD₃, Cl₃) of the resultant reactive surfactant, measured values (δ/ppm) including 0.92 (3H), 1.30 (20H), 1.95 (3H), 3.50 (8H), 4.15 (2H), 4.69 (2H), 5.50 (1H) and 6.05 (1H) were obtained, thus identifying synthesis of the objective reactive surfactant (34).

### Example 1

5 wt. parts of titanium oxide and 3 wt. parts of the reactive surfactant (33) prepared in Synthesis Example 1 were added in 100 wt. parts of water, followed by irradiation of ultrasonic wave to form a bimolecular adsorption layer of the reactive surfactant (33) at the surface of titanium oxide particles.

To the above treated particles, 2 wt. parts of di-n-butyl fumarate and 0.05 wt. part of potassium persulfate were added, followed by polymerization reaction for 48 hours at 60° C. in a nitrogen atmosphere. After coarse particles contained in the reaction mixture were removed with a filter, objective particles contained in the removed with a filter, objective particles contained in the reaction mixture were separated by centrifugation. The resultant precipitate was repeatedly recovered by filtration and washed, followed by drying to obtain particles to which the reactive surfactant-derived amphipathic residual group was fixed at the particle surface.

The thus obtained particles were subjected to salt exchange reaction by using a methanol solution o of n-hexadecyltrimethylammonium hydride (C₁₆H₃₃(CH₃)₃NOH), followed by washing of excessive ions with acetonitrile to obtain objective electrophoretic particles 1e.

An electrophoretic liquid was prepared by dispersing 5 wt. parts of the electrophoretic particles 1e in 50 wt. parts of isoparaffin (“Isopar H”, mfd. by Exxon Corp.) colored blue by the addition of 0.1 wt. part of a dye (“Oil Blue N”, mfd. by Aldrich Corp.).

The thus prepared electrophoretic liquid was filled and sealed in a plurality of cells by the ink jet method using nozzles and a voltage application circuit was connected thereto to prepare an electrophoretic display shown in FIG. 1(a).

When blue/white contrast display was effected by the electrophoretic display, the negatively charged electrophoretic particles 1e were excellent in dispersibility. Further, particle agglomeration and display degradation were not observed even when the electrophoretic display was driven for a long time. Thus, it was confirmed that the electrophoretic particles 1e were a durable material with high reliability.

### Example 2

An electrophoretic liquid, containing 5 wt. parts of electrophoretic particles 1e and 50 wt. parts of isoparaffin (Isopar H) colored blue by the addition of 0.1 wt. part of a dye (Oil Blue N), prepared in the same manner as in Example 1 was encapsulated in microcapsules 1i through in situ polymerization. A film material was urea-formaldehyde resin. The thus prepared microcapsules 1i were disposed on a substrate by the ink jet method using nozzles, and a voltage application circuit was connected thereto to prepare an electrophoretic display shown in FIG. 1(b).

When blue/white contrast display was effected by the electrophoretic display, the negatively charged electrophoretic particles 1e were excellent in dispersibility. Further, particle agglomeration and display degradation were not observed even when the electrophoretic display was driven for a long time. Thus, it was confirmed that the electrophoretic particles 1e were a durable material with high reliability.

### Example 3

5 wt. parts of carbon black and 3 wt. parts of the reactive surfactant (34) prepared in Synthesis Example 2 were added in 100 wt. parts of water, followed by irradiation of ultrasonic wave to form a bimolecular adsorption layer of the reactive surfactant (33) at the surface of carbon black particles.

To the above treated particles, 2 wt. parts of styrene and 0.05 wt. part of potassium persulfate were added, followed by polymerization reaction for 50 hours at 55° C. in a nitrogen atmosphere. After coarse particles contained in the reaction mixture were removed with a filter, objective particles contained in the removed with a filter, objective particles contained in the reaction mixture were separated by centrifugation. The resultant precipitate was repeatedly recovered by filtration and washed, followed by drying to obtain particles to which the reactive surfactant-derived amphipathic residual group was fixed at the particle surface.

The thus obtained particles were subjected to salt exchange reaction by using a perchloric acid aqueous solution, followed by washing of excessive ions with acetonitrile to obtain objective electrophoretic particles 6e.

An electrophoretic liquid was prepared by dispersing 5 wt. parts of the electrophoretic particles 6e in 100 wt. parts of isoparaffin (Isopar H).

The thus prepared electrophoretic liquid was filled and sealed in a plurality of cells by the ink jet method using nozzles and a voltage application circuit was connected thereto to prepare an electrophoretic display shown in FIG. 6(a).

When black/white contrast display was effected by the electrophoretic display, the positively charged electrophoretic particles 6e were excellent in dispersibility. Further, particle agglomeration and display degradation were not observed even when the electrophoretic display was driven for a long time. Thus, it was confirmed that the electrophoretic particles 6e were a durable material with high reliability.

### Example 4

An electrophoretic liquid, containing 5 wt. parts of electrophoretic particles 1e and 100 wt. parts of isoparaffin (Isopar H), prepared in the same manner as in Example 3 was encapsulated in microcapsules 6j through interfacial polymerization. A film material was urea-formaldehyde resin. The thus prepared microcapsules 6j were disposed on a substrate by the ink jet method using nozzles, and a voltage application circuit was connected thereto to prepare an electrophoretic display shown in FIG. 6(b).

When black/white contrast display was effected by the electrophoretic display, the positively charged electrophoretic particles 6e were excellent in dispersibility. Further, particle agglomeration and display degradation were not observed even when the electrophoretic display was driven for a long time. Thus, it was confirmed that the electrophoretic particles 6e were a durable material with high reliability.

### Example 5

An electrophoretic liquid was prepared by dispersing 5 wt. parts of white electrophoretic particles prepared in the same manner as in Example 1 and 5 wt. parts of black electrophoretic particles prepared in the same manner as in Example 3 in 100 wt. parts of isoparaffin (Isopar H). The thus prepared electrophoretic liquid was filled and sealed in a plurality of cells by the ink jet method using nozzles, and a voltage application circuit was connected thereto to prepare an electrophoretic display shown in FIG. 1(b).

When black/white contrast display was effected by the electrophoretic display, the two types of electrophoretic particles having different charge polarities were excellent in dispersibility. Further, particle agglomeration and display degradation were not observed even when the electrophoretic display was driven for a long time. Thus, it was confirmed that the electrophoretic particles 1e were a durable material with high reliability.

### Example 6

An electrophoretic liquid prepared in the same manner as in Example 5 was encapsulated in microcapsules 1i through coascervation process. A film material was gelatin. The thus prepared microcapsules 1i were disposed on a substrate by the ink jet method using nozzles, and a voltage application circuit was connected thereto to prepare an electrophoretic display shown in FIG. 1(b).

When black/white contrast display was effected by the electrophoretic display, the two types of electrophoretic particles having different charge polarities were excellent in dispersibility. Further, particle agglomeration and display degradation were not observed even when the electrophoretic display was driven for a long time. Thus, it was confirmed that the electrophoretic particles 1e were a durable material with high reliability.

As described hereinabove, according to the present invention, without adding the charging agent or the dispersion agent, it is possible to provide the electrophoretic particles exhibiting chargeability and dispersibility. Further, by using the electrophoretic particles of the present invention, it is possible to provide a high responsible electrophoretic display which causes no agglomeration of electrophoretic particles and display degradation even when the electrophoretic display is driven for a long time.

1. An electrophoretic particle having a surface to which at least an amphipathic residual group derived from a reactive surfactant is fixed.

2. An electrophoretic particle according to claim 1, wherein said electrophoretic particles are selected from the group consisting of pigment particles, polymer-coated pigment particles, and polymer particles colored with a dye.

3. An electrophoretic particle according to claim 1, wherein said reactive surfactant has a reactive function group comprising an unsaturated hydrocarbon group.

4. An electrophoretic particle according to claim 1, wherein said reactive surfactant has a hydrophobic portion comprising an aliphatic hydrocarbon chain having 4-30 carbon atoms.

5. An electrophoretic particle according to claim 1, wherein said reactive surfactant has a hydrophobic portion comprising an ionic functional group.

6. An electrophoretic liquid comprising such electrophoretic particles according to claim 1 and a dispersion medium.

7 An electrophoretic display comprising:
a pair of substrates,
a first electrode and a second electrode which are disposed on the pair of substrates,
an electrophoretic liquid, comprising electrophoretic particles and a dispersion medium, disposed between the pair of substrates, said electrophoretic particles being moved by applying a voltage to said first and second electrodes to effect display,
wherein each electrophoretic particle has a surface to which at least an amphipathic residual group derived from a reactive surfactant is fixed.

8. A process for producing electrophoretic particles, comprising the steps of:
adsorbing at least a reactive surfactant on a particle surface, and
fixing an amphipathic residual group attributable to the reactive surfactant to the particle surface by a chemical reaction of a reactive functional group possessed by the reactive surfactant.

9. A process according to claim 8 wherein the chemical reaction of the reactive functional group possessed by the reactive surfactant is polymerization reaction.

10. A process according to claim 8, wherein the amphipathic residual group attributable to the reactive surfactant is fixed to the particle surface by a copolymerization reaction of the reactive surfactant with a comonomer.

11. An electrophoretic liquid comprising such electrophoretic particles according to claim 2 and a dispersion medium.

12. An electrophoretic liquid comprising such electrophoretic particles according to claim 3 and a dispersion medium.

13. An electrophoretic liquid comprising such electrophoretic particles according to claim 4 and a dispersion medium.

14. An electrophoretic liquid comprising such electrophoretic particles according to claim 5 and a dispersion medium.

15. A process according to claim 9, wherein the amphipathic residual group attributable to the reactive surfactant is fixed to the particle surface by a copolymerization reaction of the reactive surfactant with a comonomer.
